(19) United States
(12) Patent Application Publication
(10) Pub. No.: US 2003/0197737 A1
(43) Pub. Date: Oct. 23, 2003

(54) 2D/3D web browsing system

(76) Inventor: Jong Min Kim, Seoul (KR)

Correspondence Address: WILDMAN, HARROLD, ALLEN & DIXON, 225 WEST WACKER DRIVE, CHICAGO, IL, 60606, US

(21) Appl. No.: 09/779,978

(22) Filed: Feb. 9, 2001

(30) Foreign Application Priority Data
Feb. 9, 2000 (KR) 2000-5910

(51) Int. Cl. G06F 3/14

(52) U.S. Cl. 345/781; 345/803

(57) ABSTRACT

The present invention is directed to a 2D/3D web browser for displaying both 2D and 3D information in a window. A web browser for browsing web sites providing two-dimensional (2D) or three dimensional (3D) information is disclosed. The 2D/3D web browser of the present invention comprises a software for accessing a web site and requesting information; and a display for displaying information provided by the web site responding to the request on a display screen having a 2D/3D switchable window and a 3D-only window; wherein, if the information is 3D contents, it is displayed on a combined area of the 2D/3D switchable window and the 3D-only window, and, if the information is 2D contents, it is displayed on the 2D/3D switchable window.

### FIELD OF THE INVENTION

The present invention relates generally to a web browser, and more particularly, to a browser and a method for browsing two-dimensional (2D) and three-dimensional (3D) contents simultaneously.

### BACKGROUND OF THE INVENTION

These days, the Internet provides us with a lot of up-to-date news very quickly and conveniently. Most of the information provided on the Internet consists of two-dimensional contents using HTML (Hyper Text Markup Language). Information search on the Internet is performed through two-dimensional web browsers such as “Internet Explorer™” or “Netscape Navigator™” supporting HTTP (Hyper Text Transfer Protocol). In order to navigate the Internet with either of these two-dimensional web browsers, a user must enter a URL directly or click a desired URL in the bookmark, which contains frequently visited sites, or in a history folder which lists the URLs of recently-visited sites. If the user doesn't know the URL of a site that provides the information he/she is looking for, the user should conduct a search through a search site such as Yahoo™ or Altavista™.

With the rapid growth of electronic commerce, it has become crucial to display products in three-dimension in browsers and to display and to be able to search three-dimensional content. Services for three-dimensional virtual space are provided within the Internet environment through the use of three-dimensional technologies such as VRLM or OpenGL. To view such three-dimensional content, three-dimensional viewers are also needed.

FIG. 1 depicts a block diagram of the overall configuration of the web browsing system for navigating and displaying 2D or 3D information on a network. In this system, a 2D browser 105 requests information from a web server 115 which contains 2D contents 120, and then displays the 2D information provided from the web server 115. When a user navigates 2D content with a 2D browser, he/she must use a 3D viewer to view the 3D information, where the 3D viewer is provided in the form of a plug-in program apart from the browser.

FIG. 3 depicts a block diagram of an internal structure of a prior art browsing system for providing 2D and 3D information. The system shown in FIG. 3 can be, for example, a personal computer or a workstation capable of web surfing. A CPU, an input device, a display device, a video driver, OS, ROM, RAM, etc., which are shown in FIG. 3, are basic functional blocks that are generally included in a computer. In order to view 3D content using the system of FIG. 3, a user must use a 3D viewer plug-in program 325, because the web browsing engine in this system is a 2D web browsing engine 305. It must be noted that this 3D viewer exists in the form of a plug-in program.

This prior art 3D viewer 110 can show moving pictures to the user, such as animation or other 3D contents that are prepared beforehand. But, a user cannot navigate 3D virtual space with this viewer. It can only display moving 3D images and cannot provide a user with the capability to navigate 3D virtual space.

There is one example of software that provides the capability to navigate 3D virtual space. FIG. 2 illustrates an example of a display (or a screen) that provides the user with the capability to navigate 3D virtual space. FIG. 2 is an example of the screen display of Active Worlds™. It also has a window for 2D texts and image files. It displays 2D and 3D contents simultaneously in the separated windows. Active Worlds™ enables the users to navigate 3D virtual space, to meet and chat with other people, and to go shopping in a 3D shopping mall in cyberspace.

The browser of Active Worlds™ has a main view window 201, which is a window for 3D virtual space. It also has a window for 2D web browsing 202, and a chat history window 203. The main view window 201 is for displaying and navigating the 3D virtual space. The 2D web browser 202 integrated in Active Worlds™ is similar to conventional web browsers. In fact, Active Worlds™ uses Microsoft's Internet Explorer to display web pages in the window contained within the Active Worlds browser. The chat history window 203 displays text messages of Active Worlds users.

If the user clicks the index when navigating 3D virtual space, the information corresponding to the index is displayed on the 2D web browser window 202. If a user clicks on a bulletin board 204 in the 3D virtual space window 201 to see the content of the bulletin board 204, the content is displayed in the 2D web browser window 202. The efficient display of 2D information is difficult because the size of the 2D web browser window 202 is much smaller than conventional 2D web browsers. In addition, the block diagram of the browsing system that enables a user to navigate 3D virtual space like Active Worlds of FIG. 2 is also illustrated in FIG. 4.

This prior art browser cannot display 2D contents in the 3D virtual space window 201; it must display the 2D contents in the 2D web browser window 202. Accordingly, this prior art example has some shortcomings. When a user clicks a bulletin board containing 2D contents while navigating the 3D virtual space, the 2D contents is displayed in the other 2D web browser window 202. But this is neither natural nor convenient. If a user could see the 2D contents in the navigating window, it would be much more convenient and user-friendly. In addition, this prior art browser should have separate windows for 3D virtual space and for 2D contents. This restricts the displayed screen size for both 3D and 2D contents. It also limits the availability and the convenience of the browsers. In this example, the 3D virtual space or 3D contents have very restricted usage for helping a user navigate, and it does not provide 2D and 3D contents in one window.

There is a great deal of 2D or 3D contents on the Internet. But 2D/3D browsers like Active Worlds have its own format for three-dimensional contents, and it cannot display other 3D contents in other formats. It means that if you want to navigate 3D virtual spaces with Active Worlds, the format of the 3D virtual space should be in the format supported by Active Worlds because it does not support any other format. But it requires a lot of work and time to change the existing 3D contents all over the world from other formats to the format of Active Worlds. In fact, it is impossible. Thus, providing 3D virtual space using the method of Active Worlds is very restrictive.

It is therefore an object of the present invention to provide web browsing methods and a 2D/3D web browsing system that enables a user to navigate freely between 2D and 3D contents. It is also an object of the present invention to provide web browsing methods and a 2D/3D web browsing system in which the three-dimensional contents is not a mere display configuration or animation for the user's convenience, but something that can be navigated together with 2D contents.

It is also another object of the present invention to provide a method to enable a two-dimensional contents to be displayed on a maximum-sized screen while a user navigate a three-dimensional virtual space. In addition, according to the present invention, it is also possible to display 2D and 3D content within one web browsing window and to provide an interface between 2D and 3D contents.

### SUMMARY OF THE INVENTION

The shortcomings of the prior art are overcome and additional advantages are provided through the provision of a 2D/3D web browsing system according to the present invention.

In accordance with one aspect of the invention, a web browser, for browsing web sites providing two-dimensional (2D) and three dimensional (3D) information, is provided. And, said web browser comprises means for accessing the web site and requesting information, and means for displaying 2D and 3D contents provided by the said web site on a window of a display screen responding to the said request. The window comprises 2D/3D switchable window and 3D-only window. The 3D contents are displayed on the combination of said 2D/3D switchable window and said 3D-only window, and said 2D contents are displayed on said 2D/3D switchable window.

In another aspect of the invention, a web browser, for browsing web sites providing two-dimensional (2D) and three dimensional (3D) information, is provided. And, said web browser comprises means for accessing the web site and requesting information, and means for displaying 2D and 3D contents provided by the said web site on a window of a display screen responding to the said request. The window comprises 2D/3D switchable window, and the 2D contents are displayed on said 2D/3D switchable window.

In another aspect of the invention, a 2D/3D web browser of a client computer, which browses web sites providing 2D and 3D contents, and displays said 2D and 3D contents in a window, is provided. The 2D/3D web browser comprises a browser common control engine for transmitting user input data inputted from an input device of said client computer to a web server of said web site, and for receiving a response from said web server, and instructing to perform a display according to said user input, 3D browser engine for determining whether 3D content from said web site is 3D information by comparing with 3D information cache in database, and for interpreting said 3D content, and providing an interpreted 3D content, 3D information display processor for displaying said interpreted 3D content, 2D browser engine for determining whether 2D content from said web site is 2D information by comparing with 2D information cache in database, and for interpreting said 2D content, and providing an interpreted 2D content, 2D information display processor for displaying said interpreted 2D content, 2D/3D data exchange processor controlled by said browser common control engine, and for tunneling between 2D information and 3D information between said 2D browser engine and said 3D browser engine, 2D/3D converter processor controlled by said browser common control engine, and for transforming 2D data format from said 2D browser engine to 3D data, and providing said 3D data to said 3D browser engine, and for transforming 3D data format from said 3D browser engine to 2D data and providing said 2D data to said 2D browser engine, and storage means for storing 2D and 3D cache data and cookie data.

Another purposes, features, and advantages of the present invention can be easily understood from the following description. The advantages of the present invention will be made clear from the following description with respect to the figures, too.

### BRIEF DESCRIPTION OF THE DRAWINGS

The objects and advantages of the invention will be understood by reading the following detailed description in conjunction with the drawings in which:

FIG. 1 depicts a block diagram for explaining a method for processing 2D and 3D information in a prior art web browser for displaying to a user 2D and 3D contents provided on a network;

FIG. 2 depicts an example of user interface for displaying 2D and 3D information simultaneously in a prior art web browser;

FIG. 3 depicts a block diagram of a prior art web browsing system comprising a 3D viewer and a 2D browser;

FIG. 4 depicts a block diagram of a prior art web browsing system comprising a 3D viewer;

FIGS. 5A-5C depict a display configuration of a web browser in accordance with the present invention;

FIG. 5D depicts an alternative display configuration of a web browser in accordance with the present invention;

FIG. 6 depicts a block diagram of an entire system for searching 2D and 3D information with a 2D/3D web browser in accordance with the present invention;

FIG. 7 depicts a block diagram of a web browsing system comprising a 2D/3D web browser in accordance with the present invention; and

FIG. 8 depicts a flow chart for explaining the procedure of searching information by using a 2D/3D web browser in accordance with the present invention.

### DETAILED DESCRIPTION OF THE INVENTION

The various features of the present invention will now be described with reference to the drawings, where like parts are identified with the same reference characters.

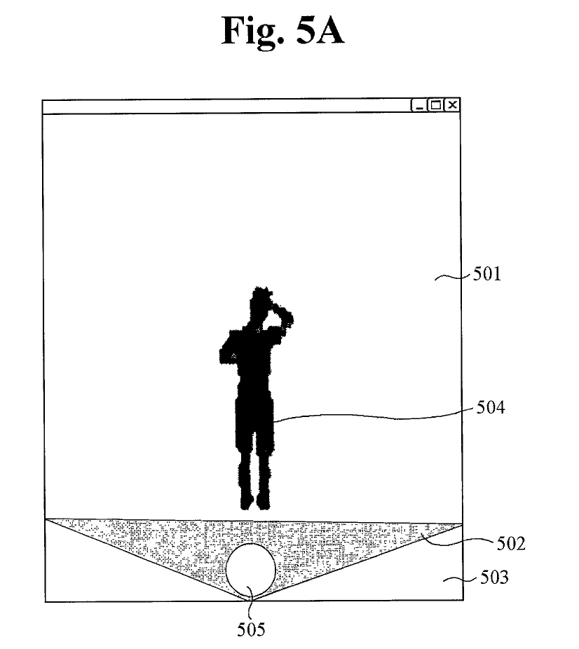

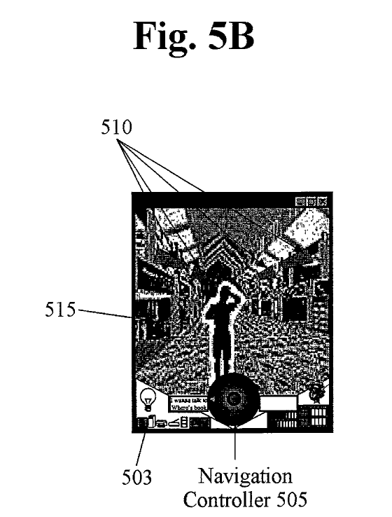

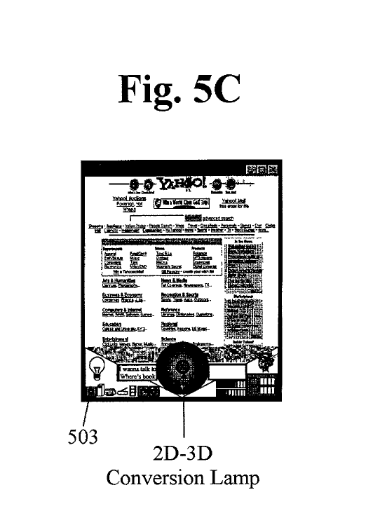

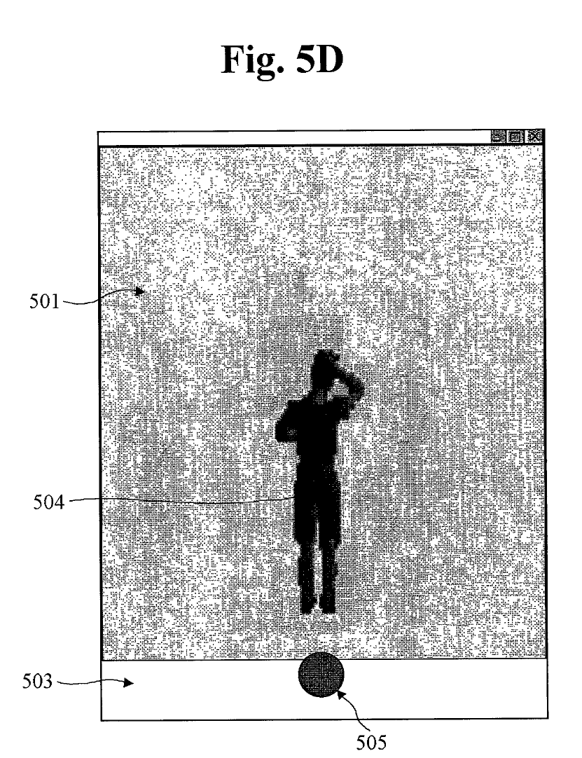

FIGS. 5A-5C depict a screen formation by a web browser in accordance with one aspect of the present invention. Referring to FIG. 5A, the 2D/3D switchable window 501 is able to display 2D and 3D information together, and the 3D-only window 502 displays 3D information only. Window for displaying 3D information, i.e., a combination of the 2D/3D switchable window 501 and the 3D-only window 502, may have a side that is not straight as distinguished from conventional rectangular windows. However, the 3D-only window 502, illustrated as a triangle, may be of a different shape such as a semicircle or rectangle. The 2D/3D switchable window 501 can be located at the 2D information display area of conventional browsers. The 3D-only window 502 can be located at unused portions in the toolbar area of the conventional browsers in order to maximize the utilization of the browser screen. In this way, when a user switches from 3D navigation to 2D information display, the latest 3D image can remain on the 3D-only window 502 as “minimized.” Likewise, a user can easily restore the latest 3D display in the 3D/2D area by clicking the above minimized 3D image.

The toolbar area 503, like that of conventional 2D web browsers provides a plurality of functions to display images on screen and tool buttons to be used in 2D/3D web browser.

The avatar 504 is an agent to perform searches in the 2D/3D web browser. It is the virtual representation of a person who is currently navigating the virtual space. In the prior art, the avatar is only an animated object moving in the 3D cyberspace, but the avatar of the present invention has a role of selecting a content when it passes through the gate 515 of the content in a 3D virtual space displayed in the browser. FIG. 5B depicts an example of the 3D display of the Internet search result. Here the signboards of stores, for example, represent the search results. When the avatar is controlled to pass through the door of a store, alternatively called the content gate 515, the web site of the store is connected.

The navigation controller 505 is used to control the direction and movement of the avatar. A user can move the avatar to surf a plurality of web sites in a cyber space displayed three dimensionally, by controlling the 3D navigation controller. The avatar 504 is made to pass through the content gate 515 having an index. At that instant, the web site corresponding to the index is connected. Also, when 2D information is displayed in the 2D/3D switchable window 501, the avatar 504 is controlled for scrolling up and down, and right and left.

The navigation controller 505 receives input from the operation of a mouse or arrow buttons of the keyboard, and controls the movement of the avatar 504. For example, it may be of a circle having 4-direction arrow buttons. It can be of any other shape to satisfy a user's requirement, such as quadrangle, and pentagon. In the preferred embodiment of the present invention, the center part of the navigation controller 505 is used as a button for switching between 2D and 3D as well as an indication of 2D or 3D content.

Although the toolbar area 503, the 3D navigation controller 505, and 3D-only window 502 are currently all located in the bottom of the screen, it will be apparent to those skilled in the relevant art that they can be located at another location.

The 2D/3D web browser in accordance with the present invention is based on a 3D virtual space, and the avatar moves in the 3D virtual space. A user can access a desired web site by having the avatar pass through the content gate having index corresponding to the desired web site. If the accessed site is a site providing 3D information, 3D information is displayed on the 2D/3D switchable window 501 as well as on 3D-only window 502. Otherwise, the current 3D image would remain on the 3D-only window 502 while 2D/3D switchable window 501 would display a 2D information of the newly accessed 2D site. The size of 2D/3D switchable window 501 remains the same as that of the conventional 2D web browser. Thus, the present invention has an advantage over the prior art in that a full-screen 2D information could be displayed.

When a user wants to return to the 3D information, now remaining in the 3D-only window 502, the user only needs to click the 3D-only window, or 2D/3D switchable button in the center of the 3D navigation controller 505. Conversely, when the avatar 504 exists in a 3D virtual space, a user can return to the 2D information from the current 3D information area by clicking the center of the 3D navigation controller 505.

FIG. 5D depicts a display screen of the web browser that does not have a 3D-only window in accordance with another embodiment of the present invention. Thus, the embodiment of FIG. 5D is almost identical to the embodiment of FIG. 5A except that it lacks switching from 2D to 3D simply by clicking a 3D-only window. In the present embodiment, a user can switch between 2D display and 3D display by clicking the center of the navigation controller 505 or by clicking a predefined tool in the toolbar area 503, which includes tools for selecting 2D display and 3D display respectively. The switching between 2D and 3D display) by using the toolbar can, of course, be employed in other embodiments of the present invention. The 2D/3D switchable window 501, the toolbar area 503, the avatar 504, and the navigation controller 505 of the FIG. 5D perform the same function as described above with FIG. 5A.

The preferred embodiments have been depicted and described in detail herein. However it will be apparent to those skilled in the art that various modifications to the locations and shapes of the 2D/3D switchable window 501, the 3D-only window 502, the toolbar area 503, the avatar 504, and the navigation controller 505 in the 2D/3D web browser can be made without departing from the spirit of the present invention. The modified embodiment includes the addition of other parts and the removal of some of the above elements.

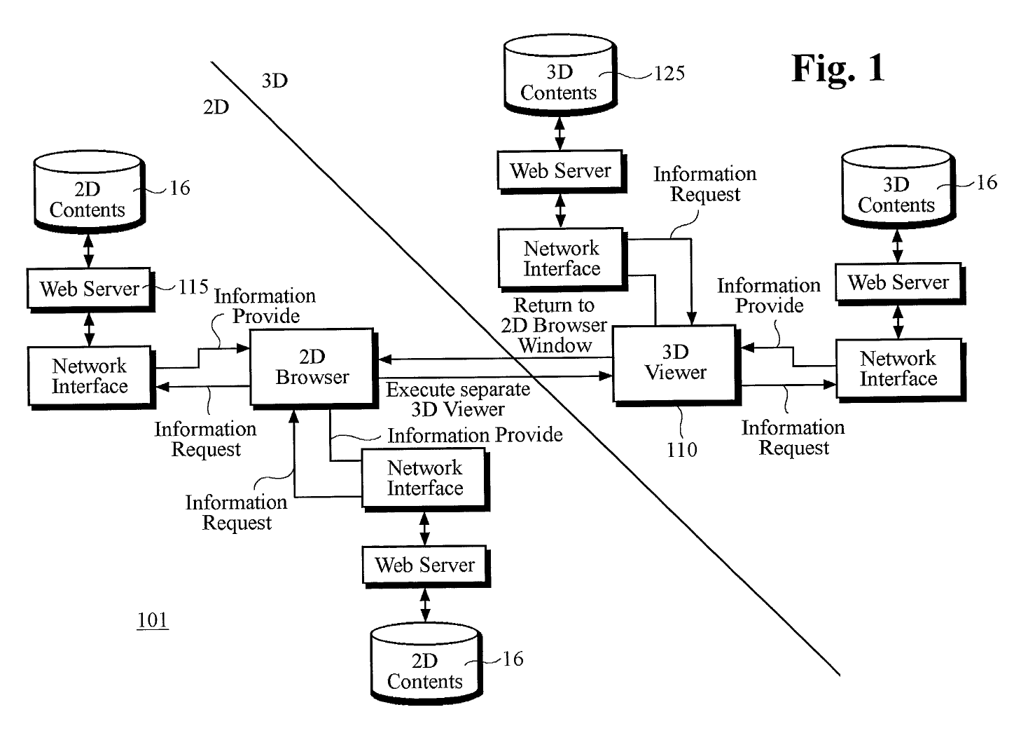

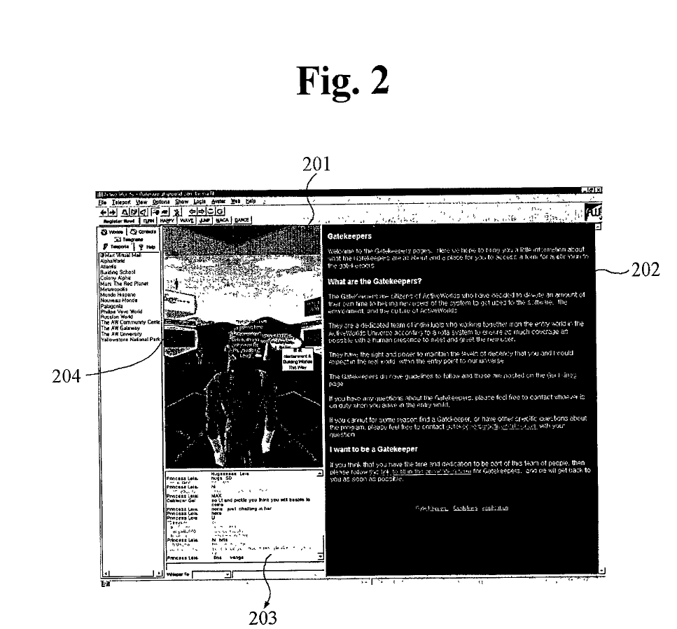

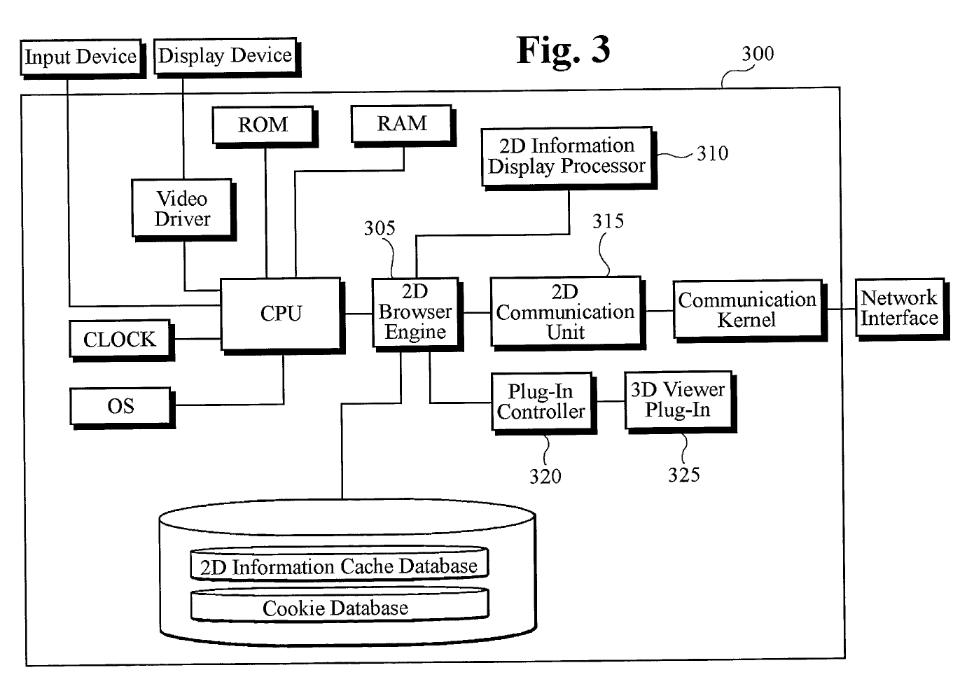

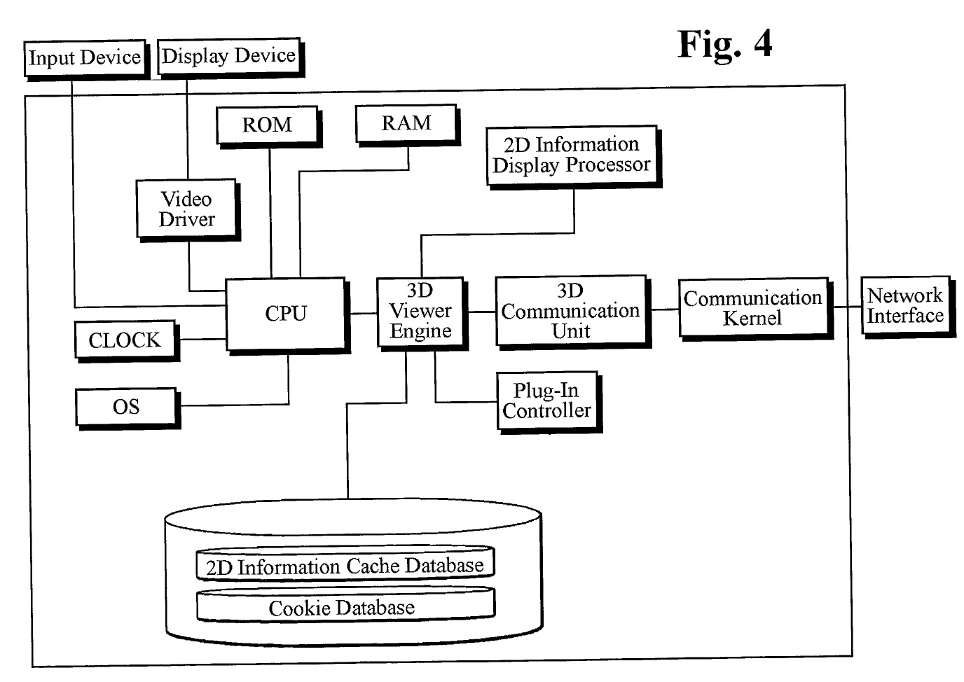

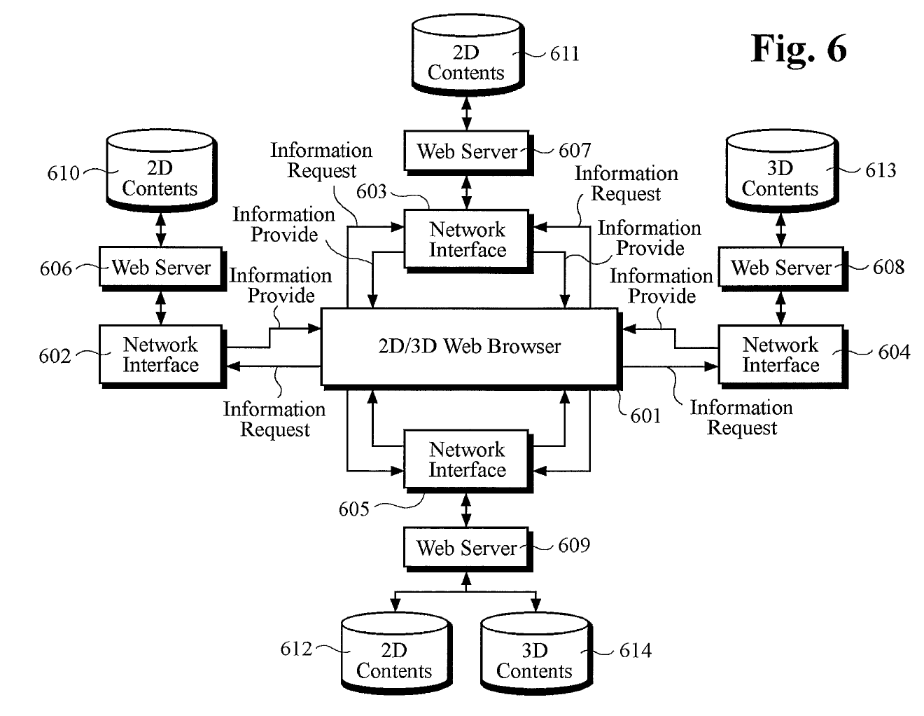

FIG. 6 is a block diagram of the entire system for navigating 2D and 3D information by using a 2D/3D web browser in accordance with the present invention. The system comprises a 2D/3D web browser 601, the network interface 602, 603, 604, 605, the web server 606, 607, 608, 609, the 2D contents 610, 611, 612, and the 3D contents 613, 614. Unlike the system illustrated in FIG. 1, the 2D/3D web browser 601 in accordance with the present invention enables a user to surf on the network regardless of whether it provides 2D contents or 3D contents. In addition, there is no need to switch between 2D browser and 3D viewer programs.

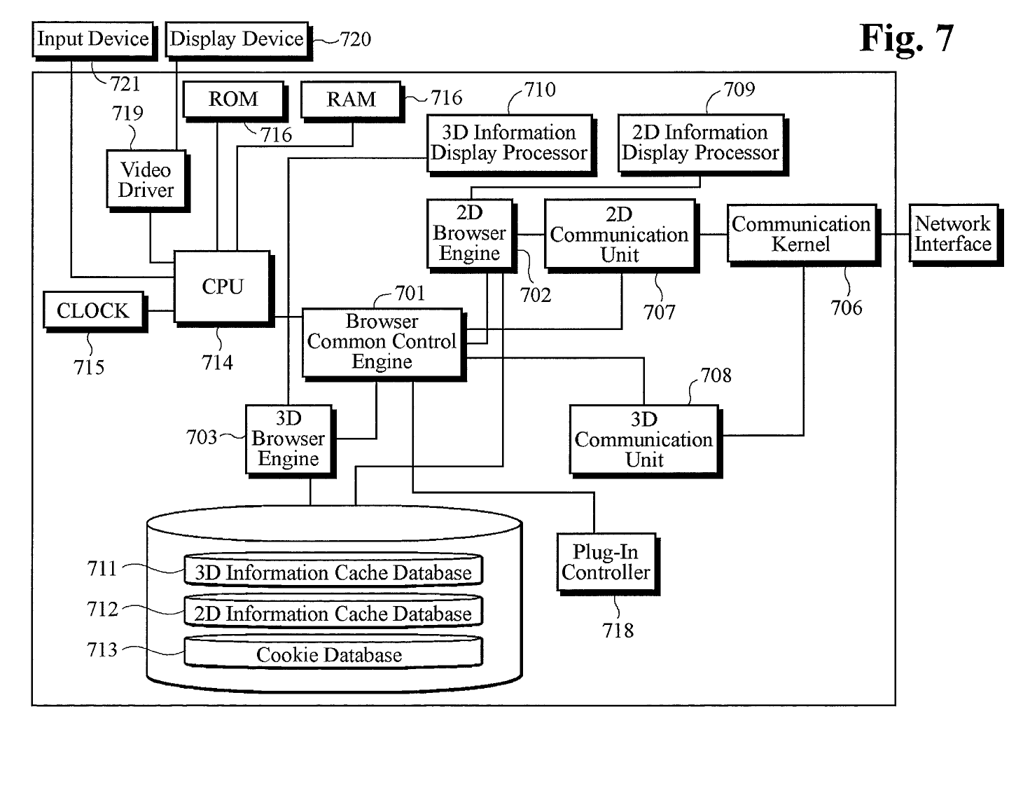

FIG. 7 shows the components of the 2D/3D web browsing system 601 in accordance with the present invention. The 2D/3D web browsing system 601 comprises a browser common control engine 701, a 2D browser engine 702, a 3D browser engine 703, a communication kernel 706, a 2D communication unit 707, a 3D communication unit 708, a 2D information display processor 709, a 3D information display processor 710, a 3D information cache database 711, a 2D information cache database 712, a cookie database 713, a CPU 714, a clock 715, ROM 716, RAM 717, and a plug-in controller 718.

The browser common control engine 701, connected to CPU 714, receives user input such as a 3D image selection, a link click, a menu selection, etc., from an input device. Then it provides instructions corresponding to the user input to the 2D browser engine 702 or the 3D browser engine 703 depending on whether the currently-connected web site is two-dimensional or three-dimensional. It further includes an event interpreter that interprets all the events relating to instructions inputted by a user inputted via a browser. That is, a 3D image selection, a link click, a menu selection, etc. are processed as events and forwarded to the browser common control engine 701 as such. The 2D browser engine 702 verifies if 2D data supplied from the 2D communication unit 707 is 2D information by comparing it with 2D information cache 712 on the database, and interprets the 2D data, and provides the interpreted 2D data to the 2D information display processor 709. It parses the HTML-written data received from a remote server and performs a rendering. Parsing as one aspect of compiling is receiving commands of a source program, on-line commands, mark-up tags, etc., and dividing them into sub-parts such as nouns, verbs, and their attributes or options to get them to be processed by other programs, which are other components of the compiler. Rendering means interpreting the sub-parts and converting them into the data representing a screen size, a screen configuration, and a font size, etc. to be displayed on the screen. The 3D browser engine 703 is connected to the CPU 714, and verifies if 3D data supplied from the 3D communication unit 708 is 3D information by comparing with 3D information cache 711, and interprets the 3D data, and provides the interpreted 3D data to the 3D information display processor 710. The 3D browser engine 703 has a similar configuration to that of 2D browser engine 702, but the data provided by the server has the VRML-form. Accordingly, the 3D browser engine 703 also performs the same functions of parsing and rendering, but has different configuration for those functions. As for 2D browser engine and 3D browser engine, 2D/3D engine APIs provided by the browser development companies can be used. For example, the 2D engine APIs are provided by the present applicant, Microsoft, Netscape, etc., and the 3D engine APIs are provided by the present applicant, Sun Microsystems, and Silicon Graphics. By utilizing the above engine APIs and Skin APIs provided by these companies, those skilled in the art can implement the browser. The communication kernel 706 distributes the 2D and 3D information received through the network to the 2D communication unit 707 and the 3D communication unit 708, respectively. The 3D communication unit 708 provides 3D information network data inputted through the communication kernel 706 to the browser common control engine 701. The 2D information display processor 709 generates 2D images and provides them to the display device to display the information provided from the 2D browser engine 702 on the display device. The 3D information display processor 710 generates 3D images and provides them to the display device to display the information provided from the 3D browser engine 703 on the display device. The plug-in controller 718 installs or removes the plug-in programs for displaying the various data that is not supported by the browser to expand the function of the browser.

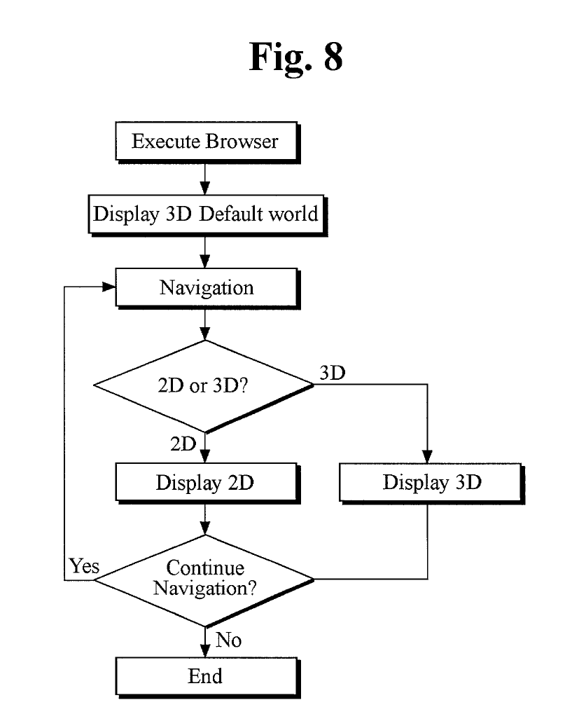

FIG. 8 depicts a flow chart of the procedure for displaying the 2D information and the 3D information at a time on a window in the browser of the present invention. The detailed procedure is described in accordance with the embodiment of FIGS. 5A-5C.

When a user executes the 2D/3D web browser in accordance with the present invention, instructions are forwarded to the browser common control engine 701 through an input device. Then, the browser common control engine 701 activates the 3D browser engine 703. In response the 3D browser engine 703 requests and receives the version information of the default world, which is saved in a server, through a 3D communication unit 708, a communication kernel 706, and a network interface.

The 3D browser engine 703 compares the received default world version information with the default world version information saved in the 3D information cache database 711. If they are the same, the 3D browser engine 703 receives the virtual world data saved in the 3D information cache database 711, and displays the virtual world on the 2D/3D switchable window 501 and 3D-only window 502 through the 3D information display processor 710. If they are different, the 3D browser engine 703 requests data of new version of a default world from the server.

When the 3D browser engine 703 receives data, it saves the data in the 3D cache database 711, and simultaneously displays the virtual world on the 2D/3D switchable window 501 and 3D-only window 502 through the 3D information display processor 710. A user can get an avatar to pass through a content gate while navigating the 3D virtual world. When the avatar passes through the content gate, the 3D browser engine 703 can detect a Web site corresponding to the content gate. At this time, if the detected site provides 3D data, the 3D browser engine 703 requests and receives the version of the world of that site through the 3D communication unit 708, communication kernel 706, and network interface. The received world version information is compared with the version information saved in a 3D cache database 711. If they are the same, the data of the 3D cache database 711 are displayed on the screen. If they are different, the 3D data of the detected site are received, and then displayed on the screen by a 3D browser engine 703 controlling a 3D information display process 710, and simultaneously the received 3D data are saved in the 3D cache database 711.

If the data of the site are two-dimensional, the 3D browser engine 703 informs the browser common control engine 701 that the content to be displayed is 2D and provides the URL of the 2D site. Then, the browser common control engine 701 activates the 2D browser engine 702.

The browser common control engine 701 requests the version information of the 2D site from the server of the 2D site through a 3D communication unit 708, a communication kernel 706, and a network interface, and then receives the information. The version information of the 2D site is compared with the version information of the 2D information cache database 712 for the site. If they are the same, the 2D data saved in the 2D information cache database 712 is displayed on the screen. If they are different, the data from the server of the site is displayed by controlling the 2D information display processor 709, and simultaneously, the new 2D data is saved in the 2D information cache database 712. At this time, the 2D information is displayed only in the 2D/3D switchable window.

When a user clicks a 3D-only window 502, or press a 2D/3D switch button in the center of the navigation controller, or presses toolbar shaped- switch button to return to the previous 3D information, the instruction is directed to the browser common control engine 701 through an input device 721 and a CPU 714. Then, the browser common control engine 701 activates the 3D browser engine 703, and the previous 3D information can be displayed on a screen.

In the above, it is explained that the 3D browser engine 703 is executed at first when a user runs the browser. However, in other embodiment of the present invention, it is also possible that the 2D browser engine 702 is first executed when the user runs the browser. In other embodiment, it is also possible that when a user executes a browser, no browser engine is made to run, In that case, a blank window is displayed to allow the user to choose either 2D or 3D browser engine. In other embodiment, after a user installs the browser, the user can choose which browser engine will first run when the user starts the browser.

As described above, the 2D/3D web browser in accordance with the present invention can display both 2D information and 3D information on one browser window.

The present invention provides a browser handling the 3D information not as a simple configuration of the display screen or kind of animation for a user convenience, but as a unit that is searchable together with 2D information. The size of the 2D display screen or the size of the 3D display screen of the web browser in accordance with the present invention are same as or larger than those of the conventional web browser. The present invention provides the method for searching the Internet by utilizing the navigation of the 3D virtual space. Thus, people who are not good at the Internet can easily search the Internet by having the avatar move through the content gates.

The invention has been described with reference to a particular embodiment. However, it will be readily apparent to those skilled in the art that it is possible to embody the invention in specific forms other than those of the preferred embodiment described above. This may be done without departing from the spirit of the invention.

Although preferred embodiment have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A web browser for browsing web sites providing two-dimensional (2D) or three dimensional (3D) information, said web browser comprising:
means for accessing a web site and requesting information; and
means for displaying information provided by said web site responding to the said request on a display screen having a 2D/3D switchable window and a 3D-only window,
wherein, if said information is 3D contents, it is displayed on a combined area of said 2D/3D switchable window and said 3D-only window, and, if said information is 2D contents, it is displayed on said 2D/3D switchable window.

2. The web browser of claim 1, wherein said 2D/3D switchable window is in the shape of a polygon, and said 3D-only window comprises a peripheral region of said polygon.

3. The web browser of claim 1, wherein said display screen of said 2D/3D web browser further includes:
an avatar which is a location indicator in a cyber space comprised of said web sites; and
a navigation controller for receiving an input from a user to control the movement of said avatar.

4. The web browser of claim 1, wherein said display screen of said 2D/3D web browser further comprising:
a toolbar area which adjoins said 3D-only window.

5. The web browser of claim 4, wherein said navigation controller is used for receiving an input from a user to scroll the screen when 2D information is displayed on said 2D/3D switchable window.

6. The web browser of claim 3, wherein displayed 3D information includes at least one content gate associated with an index, each said index indicating a web site, and, when said avatar is moved to enter said at least one content gate, said web browser requests access to the web server of said web site indicated by said index.

7. The web browser of claim 3, wherein said navigation controller comprises receives an input for toggling between 2D display screen and 3D display screen in said 2D/3D switchable window.

8. A method for web browsing in a system comprising a plurality of web servers comprising the steps of:
(a) requesting access to a server;
(b) receiving information from said web server responding to the request;
(c) determining if said received information is 2D information or 3D information;
(d) displaying said received information on said 2D/3D switchable window if said received information is 2D information; and
(e) displaying said received information both on said 2D/3D switchable window and on 3D-only window if said received information is 3D information.

9. A 2D/3D web browser for browsing web sites providing 2D or 3D contents, comprising:
a browser common control engine for transmitting an access request to the web server of a web site, and for receiving a response from said web server;
a 3D browser engine for determining whether information received from said web site is 3D information;
a 3D information display processor for displaying 3D content;
a 2D browser engine for determining whether information from said web site is 2D information;
a 2D information display processor for displaying 2D content;
a 2D/3D data exchange processor, controlled by said browser common control engine, for tunneling between 2D information and 3D information between said 2D browser engine and said 3D browser engine;
a 2D/3D converter processor, controlled by said browser common control engine, for transforming 2D data format from said 2D browser engine to 3D data and providing said 3D data to said 3D browser engine, and for transforming 3D data format from said 3D browser engine to 2D data and providing said 2D data to said 2D browser engine; and
storage means for storing 2D and 3D cache data.

10. A storage medium storing a program of the method for web browsing of claim 9.

11. A web browser for browsing web sites providing two-dimensional (2D) or three dimensional (3D) information, said web browser comprising:
means for accessing web sites and requesting information; and means for displaying contents provided by an accessed web site responding to the said request on a display screen,
wherein said window comprises 2D/3D switchable window, and said contents, if 2D, are displayed on said 2D/3D switchable window.

12. The web browser of claim 11, wherein said display screen of said 2D/3D web browser further comprising:
an avatar location indicator in a cyber space comprised of said web sites; and
a navigation controller for receiving an input from a user to control the movement of said avatar.

13. The web browser of claim 12, wherein displayed 3D information includes at least on content gate associated with an index, each said index indicating a web site, and when said avatar is moved to enter said at least one content gate, said web browser requests access to the web server of said web site indicated by said index.

14. The web browser of claim 11, wherein said navigation controller receives an input for toggling between 2D display screen and 3D display screen in said 2D/3D switchable window.

15. A web browser for browsing web sites providing two-dimensional (2D) and three-dimensional (3D) information, said web browser comprising:
means for displaying 2D and 3D contents provided by said web sites;
means for displaying an avatar which is a location indicator in an cyber space comprising said web sites; and
means for receiving an input from a user to control the movement of said avatar,
wherein displayed 3D information includes at least one a content gate associated with an index, each said index indicating a web site, and when said avatar is moved to enter said at least one content gate, said web browser requests access to the web server of said web site indicated by said index.
